(19) United States
(12) Patent Application Publication
(10) Pub. No.: US 2005/0033807 A1
(43) Pub. Date: Feb. 10, 2005

(54) Method and apparatus for facilitating computer-supported collaborative work sessions

(76) Inventors: John D. Lowrance, Foster City, CA (US); Andres C. Rodriguez, Santa Monica, CA (US); Chih-Hung Eric Yeh, Emeryville, CA (US); Ian H. Harrison, Brooklyn, NY (US); Thomas A. Boyce, Los Gatos, CA (US)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 10/874,806

(22) Filed: Jun. 23, 2004

Related U.S. Application Data
(60) Provisional application No. 60/482,071, filed on Jun. 23, 2003.

(51) Int. Cl. G06F 15/16

(52) U.S. Cl. 709/204

(57) ABSTRACT

A method and apparatus for facilitating computer-supported collaborative work sessions solicits ideas from participants in a collaborative work session, and then prompts the participants to group the generated ideas into discrete clusters of related ideas. The participants' clusters are then aggregated to form collective clusters that represent overarching themes or ideas generated in the collaborative work session. The collective clusters and the ideas contained therein may be used by an organization, for example to address a specific need or to shape a policy.

### CROSS REFERENCE TO RELATED APPLICATIONS

This application claims the benefit of U. S. Provisional Patent Application Ser. No. 60/482,071, filed Jun. 23, 2003 (titled “Method and Apparatus for Computer Supported Brainstorming”), which is herein incorporated by reference in its entirety.

### REFERENCE TO GOVERNMENT FUNDING

This invention was made with Government support under Contract Number F30602-03-C-0001, awarded by the Air Force Research Laboratory. The Government has certain rights in this invention.

### FIELD OF THE INVENTION

The present invention relates generally to collaborative work and relates more specifically to a method and apparatus for facilitating computer-supported collaborative work sessions.

### BACKGROUND OF THE DISCLOSURE

Collaborative work sessions (or “brainstorming”) play a critical role in business processes, government policy development, intelligence analysis and many other fields. For example, such sessions help to identify key areas in which an organization or its competitors are likely to move forward and the impact that certain decisions may have on the future. As such, collaborative work sessions play a key role in planning and strategy. Unfortunately, many of the key people who could contribute most significantly to such sessions may not all be congregated in the same geographic location, or may be unable to establish a time to meet simultaneously. Conventional methods of facilitating collaborative work sessions are typically not flexible enough to account for such circumstances. Moreover, such conventional methods do not provide an effective way for the participants to build a consensus based on the work that has been collectively generated.

Thus, there is a need in the art for a method and apparatus for facilitating computer-supported collaborative work sessions.

### SUMMARY OF THE INVENTION

In one embodiment, the present invention relates to a method and apparatus for facilitating computer-supported collaborative work sessions. In one embodiment, a method solicits ideas from current participants in a collaborative work session, and then prompts the participants to group the generated ideas into discrete clusters of related ideas. The method aggregates the participants' clusters to form collective clusters that represent overarching themes or ideas generated in the collaborative work session. The collective clusters and the ideas contained therein may be used by an organization, for example to address a specific need or to shape a policy.

### BRIEF DESCRIPTION OF THE DRAWINGS

The teachings of the present invention can be readily understood by considering the following detailed description in conjunction with the accompanying drawings, in which:

FIG. 1 illustrates a flow diagram that depicts one embodiment of a method for facilitating computer-supported collaborative work sessions, according to the present invention;

FIG. 2 illustrates one embodiment of a display that the method illustrated in FIG. 1 may present to a user/moderator in order to establish parameters for a new collaborative work session;

FIG. 3 illustrates one embodiment of a display that provides an interface for a user to select any one of multiple active collaborative work sessions in which to participate;

FIG. 4 illustrates one embodiment of a display that the method illustrated in FIG. 1 may present to collaborative work session participants in order to solicit ideas;

FIG. 5 illustrates one embodiment of a display that may be used to display session parameters and objectives to collaborative work session participants;

FIG. 6 illustrates one embodiment of a display for enabling collaborative work session participants to group posted ideas into clusters;

FIG. 7 illustrates another embodiment of a display for enabling session participants to group posted ideas into clusters;

FIG. 8 illustrates one embodiment of a display for simultaneously displaying individual participant and collective clusters;

FIG. 9 illustrates one embodiment of a display for enabling participants to contribute and/or rank suggested names for collective clusters; and

FIG. 10 is a high level block diagram of the present method for facilitating computer-supported collaborative work sessions that is implemented using a general purpose computing device.

To facilitate understanding, identical reference numerals have been used, where possible, to designate identical elements that are common to the figures.

### DETAILED DESCRIPTION

The present invention relates to a method and apparatus for facilitating computer-supported collaborative work sessions. In one embodiment, the inventive method and apparatus capture key aspects of the brainstorming process in a computer-supported cooperative work environment. Those skilled in the art will appreciate that the term “computer” may be interpreted to mean any sort of computing device, including, without limitation, a desktop computer, a laptop computer, a palm-sized computer, a personal digital assistant, a tablet computer, a cellular telephone and the like. Thus, an individual may participate in a collaborative work session structured according to the present invention using any of these devices, among others. The present invention enables users to participate in a single collaborative work session from any geographic location to privately generate, share and view ideas with others as if involved in a synchronous meeting. The invention also enables users to participate at any time in the collaborative work process, e.g., whenever inspiration strikes or whenever time is available. Participants may therefore come and go during the collaborative work session without interrupting the continuity of the process.

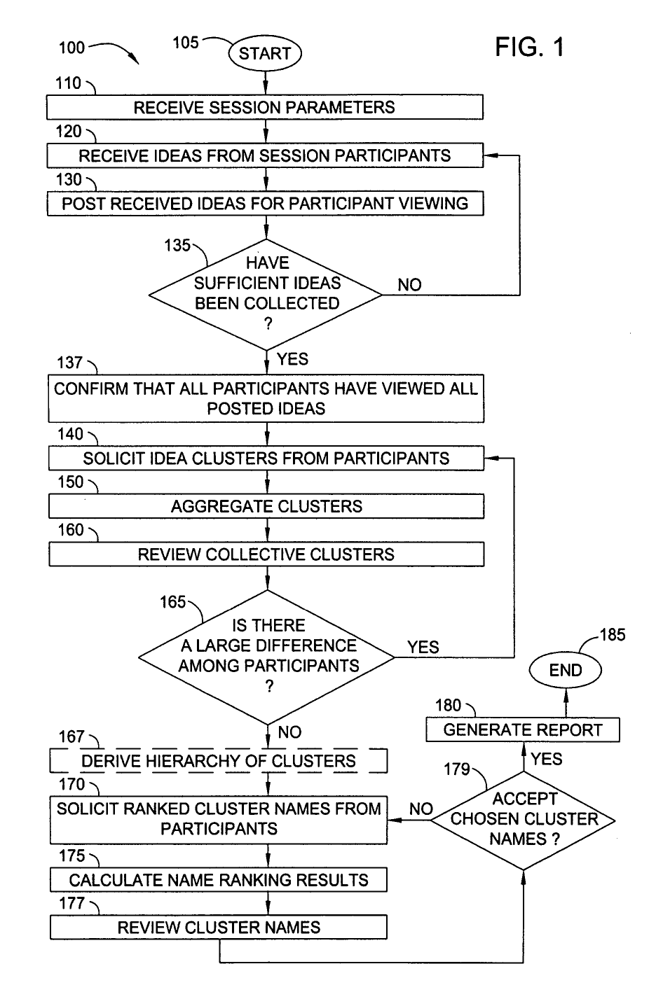

FIG. 1 illustrates a flow diagram that depicts one embodiment of a method 100 for facilitating computer-supported collaborative work sessions, according to the present invention. The method 100 is initialized at step 105 and proceeds to step 110, where the method 100 receives parameters for a collaborative work session (e.g., a from a user, a session moderator or a synthetic moderator). In one embodiment, adjustable session parameters include one or more of the following: the description of the need to be addressed by the session, the schedule for completing various stages of the session, whether participants should remain anonymous, how many contributions an individual participant must make before being allowed to view a specified number of contributions from others, the types of files (e.g., text files, images, etc.) that participants may contribute, the total number of ideas to be generated, a total number of idea clusters to be generated, the method to be used in finding an aggregate view, the method to be used in calculating an aggregate result from individual rankings, constraints on the activities of session participants, whether synthetic participants should be deployed and how they will perform their functions, and the like. In one embodiment, step 110 further involves receiving one or more background documents (e.g., financial performance statistics, market research, product descriptions, technical papers and the like) for distribution to session participants. Documents may be distributed any form, including, but not limited to, audio, video, text and graphic form and may be provided by any means, including, but not limited to, via web server, attachment or hyperlinks.

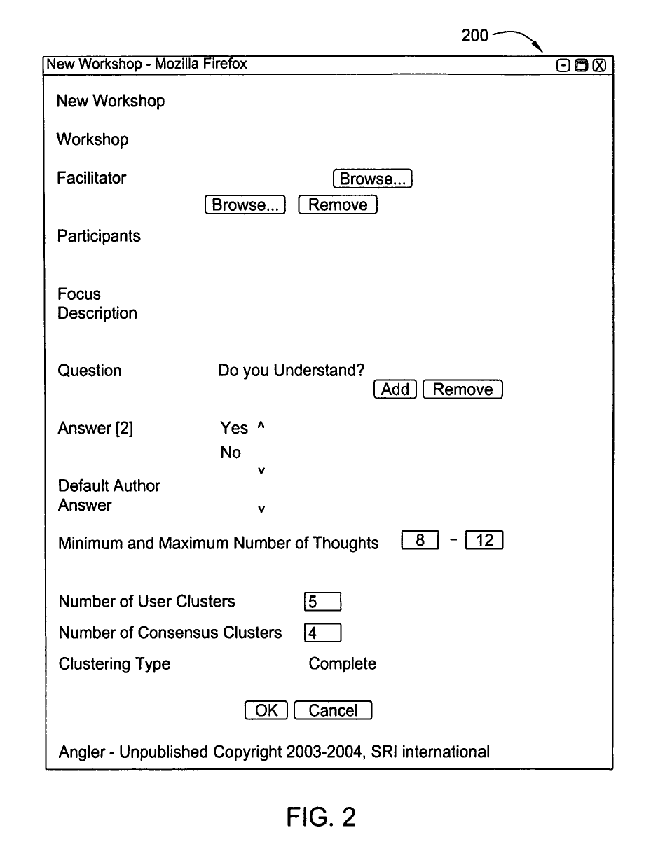

FIG. 2 illustrates one embodiment of a display 200 that the method 100 may present to a user/moderator in order to establish parameters for a new collaborative work session. In one embodiment, the method 100 presents a user with various adjustable parameters and options, including, but not limited to, naming the session, moderator and desired participants, designating a minimum or maximum number of ideas to be generated, questions for participants and the like, as explained in further detail below.

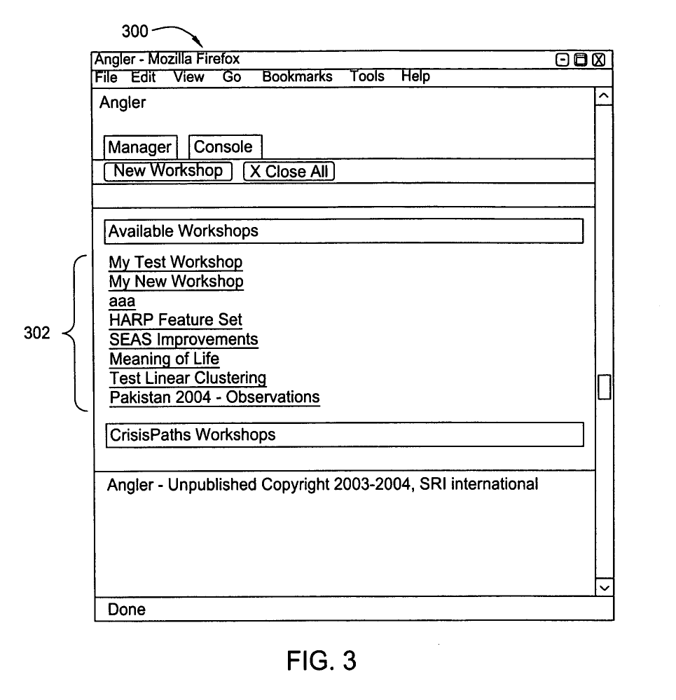

Different session parameters may be provided for a variety of different collaborative work sessions. For example, FIG. 3 illustrates one embodiment of a display 300 (e.g., for display on a user computer) that provides an interface for a user to select any one of multiple active collaborative work sessions 302 (e.g., “My Test Workshop”, “My New Workshop”, etc.) in which to participate. Each active session 302 may have different parameters.

In step 120, the method 100 receives ideas or questions from current session participants (e.g., participants that are, at a given time, “signed in” or actively participating in the collaborative work session). In one embodiment, ideas received by the method 100 each include a short “catch phrase” or summary of the idea's key concept, together with a more detailed explanation. In one embodiment, ideas received by the method 100 may include attachments or hyperlinks to supporting material or references. In one embodiment, the ideas are received in a manner that does not allow participants to immediately view each others' ideas, thereby allowing a participant to edit or further consider an idea submission before it is made available to the group. In one embodiment, ideas are received from session participants asynchronously (e.g., different participants contribute ideas at different times during the session).

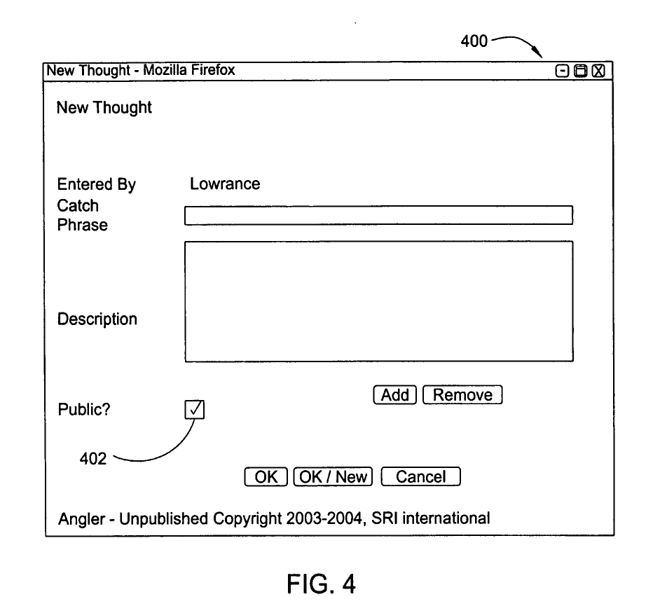

FIG. 4 illustrates one embodiment of a display 400 that the method 100 may present to session participants in order to solicit ideas. In one embodiment, the display 400 includes a checkbox 402 that enables a contributing participant to make an idea “public” by sending the idea directly to a public space and bypassing private space (e.g., for temporary storage).

In step 130, the method 100 posts the received ideas to a forum where all participants in the collaborative work session may view all submitted ideas. In one embodiment, the method 100 posts ideas in response to a user prompt indicating that a participant's idea is ready for submission or viewing. In one embodiment, the method 100 posts ideas anonymously. In another embodiment, the method 100 attributes posted ideas to the session participants who contributed the ideas. In one embodiment, ideas become incrementally available to participants once they are posted. That is, the number of ideas made visible to any particular participant may be made dependent upon the number of ideas the participant has contributed, and these parameters may be set by a user or session moderator in step 110. Thus, a contributing participant may be enabled to benefit from ideas contributed by other participants, while still being required to think for his or herself at the outset of the collaborative work session.

In one embodiment, the method 100 enables a moderator to monitor the ideas posted in step 130. The moderator may be a human supervisor or a computer program (e.g., a “synthetic moderator”) that may operate in conjunction with “synthetic” (e.g., computer program-based) participants. In one embodiment, a synthetic moderator monitors for volume of idea generation over time, and, if the rate of ideas being received by the method 100 appears to be slowing, interjects (e.g., directly or via synthetic participants) high-level ideas and questions to stimulate the human participants. In one embodiment, a database of standard aspects of problem solving, which may stimulate discussion, is maintained so that the moderator can selectively or arbitrarily interject database entries. For example, database entries could include questions such as, “Have we considered the social impact?”, “Will this solution scale?”, “How does this relate to our competition?” and the like. In one embodiment, these aspects are provided by a user or session moderator in step 110. In other embodiments, natural language and reasoning techniques (e.g., topic spotting) are implemented to interject more specific or relevant questions.

In one embodiment, a synthetic moderator employs several techniques to understand ideas coming from the participants and to enhance the collaborative work process. In one embodiment, a synthetic moderator uses Natural Language Processing (NLP) technology to parse ideas and generate canonical representations of the parsed ideas. In one embodiment, the canonical representation is a tree of words that can be mapped to a lexical database, knowledgebase or system (for example, such as WordNet's® (of Princeton University's Cognitive Science Laboratory) “synsets”(syntactic sets)) for further understanding and topic mapping. In one embodiment, a synthetic moderator uses pattern recognition technology to spot analogies between a current collaborative work session and previous, saved collaborative work sessions that are stored in corporate memory. In one embodiment, if a collaborative work session is stored in the form of a graph, graph edit distance can provide a similarity metric. In another embodiment, coverage metrics are used to compare the current collaborative work session against a complete lexical graph (e.g., a WordNet® graph), in order to determine whether closely related ideas have been considered. For example, in one embodiment, a graph of the current collaborative work session is overlaid on top of a WordNet® graph.

In another embodiment, a synthetic moderator is enabled to filter duplicate ideas or to merge very closely related ideas. In one embodiment, the synthetic moderator provides feedback to individual session participants indicating when an idea that a participant has just submitted is similar to an existing idea. In one embodiment this task is automated, for example via a mapping between WordNet® synsets describing each idea. Since WordNet® synsets map words back to their original roots, two ideas may be identified as comparable even if they are expressed differently.

In one embodiment, synthetic participants are enabled that embody the “corporate memory” of an organization. In one embodiment, synthetic participants can access databases containing, for example, financial results, policies, white papers, briefs, prior collaborative work session results and the like. In one embodiment, a synthetic participant uses topic spotting, semantic indexing and/or other methods to identify relevant background information in a database that can be introduced into the collaborative work session. In another embodiment, a synthetic participant is enabled to respond to questions posted to the session, such as, “Will the corporate memory participant post our financial rollup for 1997?”.

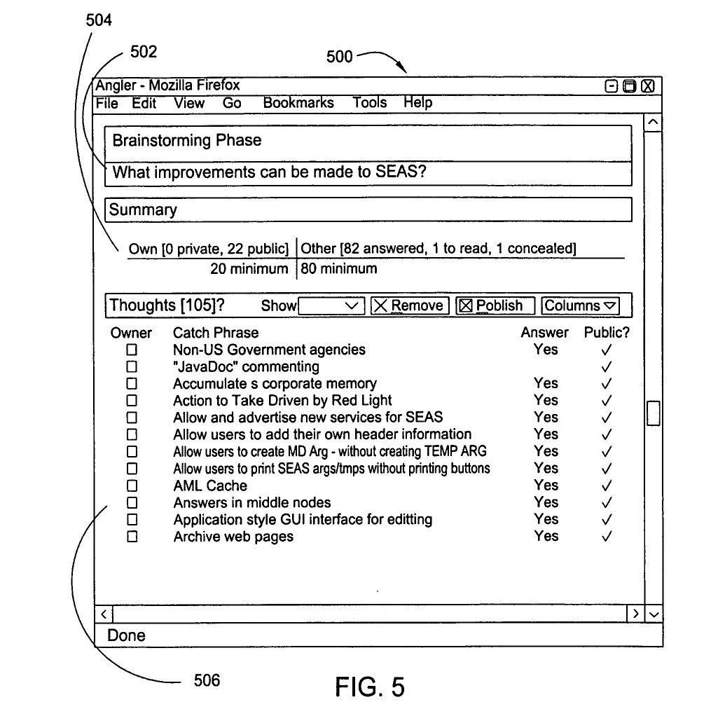

FIG. 5 illustrates one embodiment of a display 500 that may be used to display collaborative work session parameters and objectives to session participants. In one embodiment, the display 500 comprises three main areas. A first area 502 (e.g., the “Brainstorming Phase” area) indicates the focus of the current session (e.g., “What improvements can be made to SEAS?”). In one embodiment, the first area 502 is updated throughout the collaborative work session to reflect the current status of the session and/or to provide additional instructions to the session participants. A second area 504 provides a summary of the number of ideas contributed, by the user and by other session participants, to the current session. In one embodiment, the second area 504 also displays the minimum number of ideas that each participant should contribute, the number of ideas from other participants that are currently concealed, the number of ideas that have been viewed, or a combination thereof. A third area 506 lists all ideas that the user currently has access to. In one embodiment, displayed ideas are sortable.

Referring back to FIG. 1, in step 135, the method 100 determines if sufficient ideas have been collected. In one embodiment, a session parameter set by a user or session moderator in step 110 defines a threshold for the sufficiency of collected ideas. In one embodiment, the parameter defines a minimum number of total ideas to be collected and/or posted from participants, a minimum number of ideas to be collected from each individual participant, a time limit for collecting ideas, or a combination of these requirements. If the method 100 determines in step 135 that sufficient ideas have been collected, the method 100 proceeds to step 137. Alternatively, if the method 100 determines that sufficient ideas have not been collected, the method 100 returns to step 120 to receive more ideas from session participants.

In one embodiment, if sufficient ideas have not been collected, the method 100 repeats steps 120 and 130 synchronously for all current participants, so that all current participants must post a first idea or set of ideas before any individual participant is permitted to post a second idea or set of ideas. In another embodiment, the method 100 does not repeat steps 120 and 130 synchronously for all current participants, so that any number of ideas may be posted by a particular participant regardless of the number of contributions from other participants.

In step 137, the method 100 confirms that all current participants have viewed all posted ideas, including those contributed by other participants. In one embodiment, the method 100 confirms this by asking each current participant a question about each idea. For example, the question that the method 100 presents to each participant might be, “Do you understand the idea?”. In one embodiment, the question and possible answers are defined in step 110. Once the method 100 has confirmed that all current participants have viewed all posted ideas, the method 100 proceeds to step 140. Alternatively, if the method 100 determines, based on the participants' answers to the question(s) in step 137, that all current participants have not viewed all posted ideas, or that further review of the posted ideas is necessary, the method 100 may repeat step 137 and ask additional questions in order to clarify or expand the posted ideas.

In step 140, the method 100 solicits participant feedback in order to group the posted ideas into clusters of related ideas, e.g., based on similarities perceived by the participants. In one embodiment, the method 100 receives two or more clusters from each individual participant, where each participant creates his or her clusters without knowledge of the other participants' perceptions. In one embodiment, the method 100 provides, for example via a graphical user interface, a table view of all of the posted ideas and fields or “buckets” into which the posted ideas may be placed to perform the clustering. In another embodiment, the method 100 provides a 2D/3D “idea landscape” that can be shaped by participants to arrive at a clustering using an incremental technique. In one embodiment, the clusters solicited from the participants in step 140 also include names for each cluster, as designated by the participants who created the clusters. In one embodiment, the names comprise overarching descriptions of the ideas in the cluster that indicate why the participant who created the cluster believed that the ideas in the cluster should be grouped together.

In one embodiment, the method 100 solicits clusters from participants by providing a similarity metric between ideas. In another embodiment, synthetic participants are enabled to provide clusters that present a certain perspective on the posted ideas, for example based on corporate memory (e.g., a semantic cluster could be generated out of a lexical database or reference system such as WordNet®).

In one embodiment, there are two types of clusters that the method 100 may receive from participants, depending on parameters defined in step 110 (e.g., by a moderator). A first type of cluster is a “strict-membership cluster”, where any single idea associated with the cluster may not be associated with a second cluster. A second type of cluster is a “fuzzy cluster”, where any single idea associated with the cluster may be associated with any number of other clusters.

In one embodiment, synthetic participants are deployed to semantically guide the clustering process. In one embodiment, the participants each map all of the posted ideas onto a complete lexical reference graph such as a WordNet® graph, and then calculate distance as a metric to produce clustering. That is, since a posted idea will typically be composed of several words, the distance between two ideas can be defined in a number of ways, including using similarity measures based upon distances within ontological trees as described by Mark Lazaroff and John Lowrance, “Project Genoa: Research Findings & Recommendations, Technical Report 1—Study/Services,” Veridian/SRI contract deliverable on Navy Contract No. N66001-00-D-8502, delivery order number 1, Apr. 30, 2001. In one embodiment, a suitable metric is the average of the distances between each word in a first idea and all words in a second idea. Different metrics may be developed to correspond to different emphases on the data, and different synthetic participants can provide different views. In one embodiment, multiple metrics may be employed, and metrics may be selected in step 110 during the definition of session parameters.

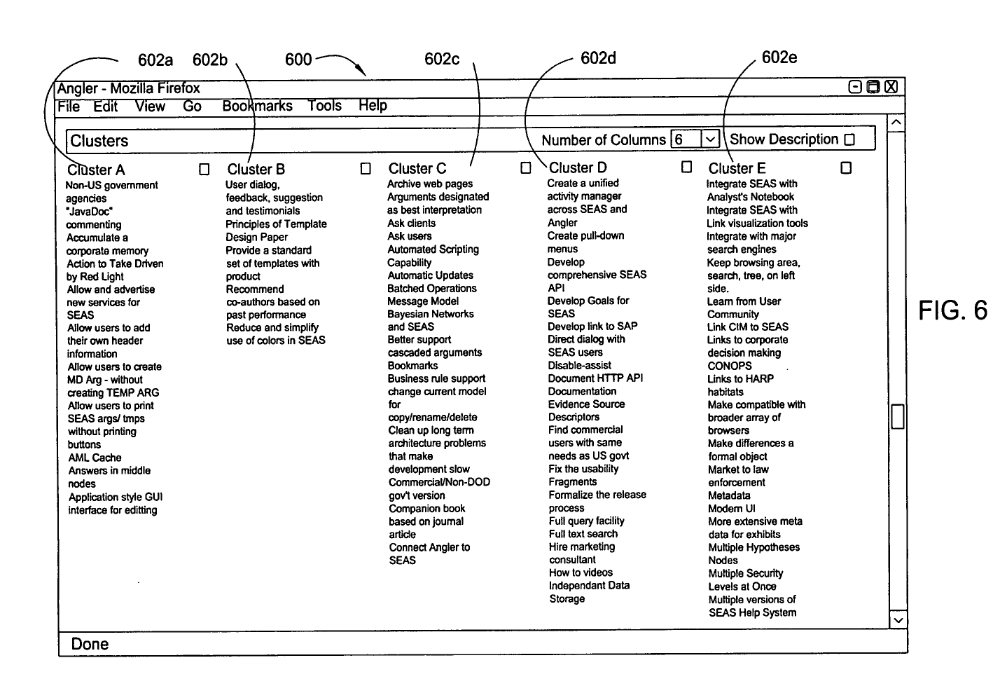

FIG. 6 illustrates one embodiment of a display 600 for enabling session participants to group posted ideas into clusters 602a-602e. In one embodiment, the number and nature of the clusters 602a-e are defined by the individual participants. In one embodiment, a portion of the display (not shown) lists all posted ideas that have not yet been placed into a cluster by the user, and the user is enabled to drag the ideas across the display and drop the ideas into a column corresponding to a cluster 602a-602e. In one embodiment, ideas are identified on the display by their catchphrases for the purposes of clustering. In another embodiment, a user may toggle the display to show either the catchphrases or the full descriptions of the ideas. In one embodiment, the displayed clusters 602a-602e are assigned default names, such as “Cluster A”, “Cluster B”, etc. In another embodiment, a participant may provide names for the clusters he or she has created.

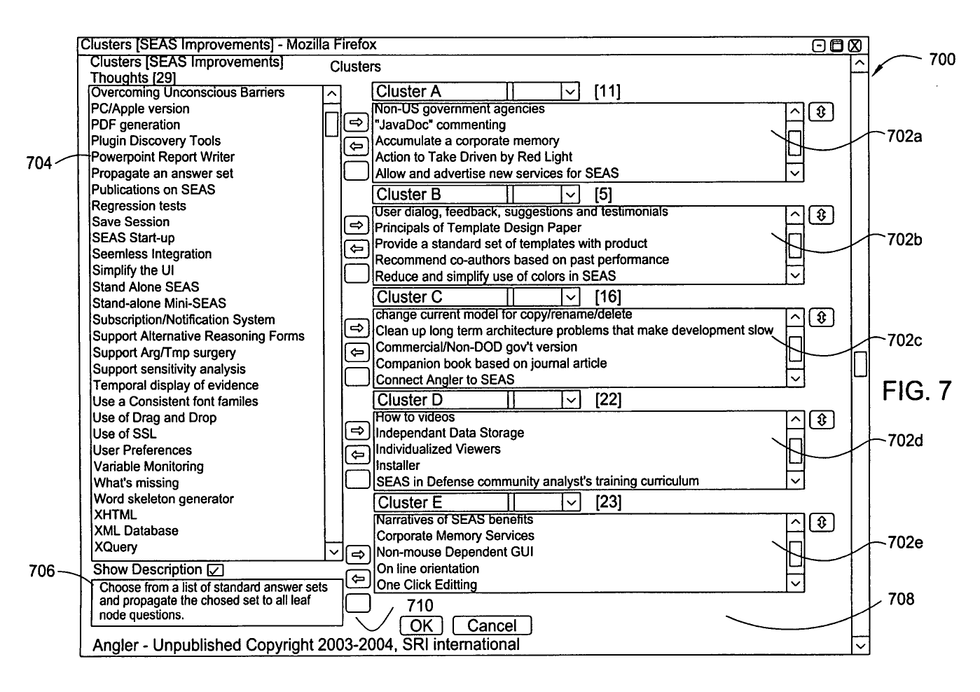

FIG. 7 illustrates another embodiment of a display 700 for enabling session participants to group posted ideas into clusters 702a-702e. The display 700 is an interface that, in one embodiment, comprises three main areas. A first area 704 lists all posted ideas by their respective catchphrases. A second area 706 displays the detailed description of the idea corresponding to a catchphrase highlighted in the first area 704. A third area 708 comprises several cluster fields 702a-702e into which ideas listed in the first area 704 may be placed. In one embodiment, each cluster field 702a-702e includes a set of buttons 710 that allow a user to move ideas from the first area 704 into a respective cluster field 702a-702e , or vice versa. For example, in one embodiment, a user may click a button associated with a given cluster field 702a-702e, so that all ideas subsequently clicked automatically are moved into the selected cluster field 702a-702e. In one embodiment, all cluster fields 702a-702e that are displayed are associated with a respective color (e.g., Red, Green, etc.) and name (e.g., Cluster A, Cluster B, etc.).

Referring back to FIG. 1, in step 150, the method 100 aggregates the clusters solicited from the participants to form collective clusters. In one embodiment, a moderator defines a number of desired collective clusters. In one embodiment, aggregation of participants' clusters is performed by agglomerative clustering, using a pair-wise number of agreeing participants between two ideas as a metric. The method 100 finds a balance between closely related ideas and similar cardinalities for the participants' clusters. In one embodiment, the method 100 assigns negative scores to collective clusters that are inversely proportional to the sizes of the collective clusters (e.g., in terms of the number of ideas contained therein), in order to prevent collective clusters from becoming too large relative to other collective clusters. In other embodiments, other types of clustering techniques may be implemented in step 150, such as spectral graph clustering.

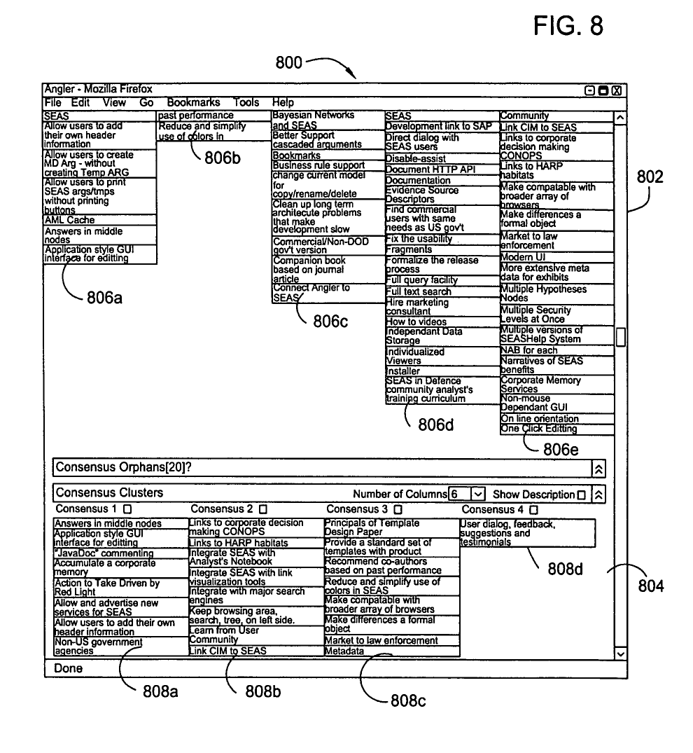

In one embodiment, the method 100 generates a display for each participant that shows that participant's own clusters relative to the collective clusters, so that the participant can see how different his or her perspective is from the group aggregation. FIG. 8 illustrates one embodiment of a display 800 for simultaneously displaying individual participant and collective clusters. In one embodiment, the display 800 comprises two main areas: a participant cluster area 802 and a collective cluster area 804. In one embodiment, the participant cluster area 802 is substantially similar to the third area 708 of the display 700, and includes several participant-generated clusters 806a-806e distinguished by color and/or name. In one embodiment, the collective cluster area 804 also comprises several collective clusters 808a-808d, distinguished by color and/or name. The number of clusters in the participant cluster area 802 and the collective cluster area 804 do not necessarily have to be equal, as many concepts proposed by participants in the initial clustering may be condensed or combined.

Referring back to FIG. 1, in step 160, the method 100 reviews the resultant collective clusters. In step 165, the method determines whether there are significant differences in the ways that the participants have clustered the posted ideas relative to the collective clusters. In one embodiment, the size of a difference that qualifies as “significant” is predefined in step 110 of the method 100. In one embodiment, the difference between clusters is calculated using Information Theory mechanisms. As defined by C.E. Shannon and W. Weaver, “The Mathematical Theory of Communication,” University of Illinois Press, Urbana Ill., 1949, the entropy of the clusters (e.g., as used in the construction of decision trees) defines the amount of information. A measure known in the art as “mutual information” defines the amount of correlation between two clusters. The average of mutual information between the aggregation (i.e., collective clusters) and each individual participant's clusters can be used to quantify the difference In one embodiment, if the method 100 detects a large difference (e.g., a difference that exceeds a predefined threshold) between the individual participants' clusters, the method 100 returns to step 140 and asks the participants to provide alternative clusters.

In one embodiment, if the variation between participants' clusters is not significant, the method 100 derives a hierarchy of collective clusters in step 167. In one embodiment, aggregation of clusters in accordance with step 150 is performed using an Agglomerative Clustering technique that inherently defines a hierarchy of collective clusters (e.g., because at any moment in the aggregation process, two sub-clusters are being assembled). In this embodiment, the hierarchy resembles a dendritric tree (or dendrogram), where aggregation is refined at each step by merging two collective clusters together.

In one embodiment, if the method 100 determines, after executing steps 160-167, that the collective clusters are not adequate for the purposes of the collaborative work session, the method 100 may initiate manual review. In another embodiment, the method 100 selects the clusters assembled by one of the participants. In one embodiment, means are provided to allow all current participants to review other participants' clusters, so that they can understand how other participants have attempted to reduce the problem or issue that is the subject of the collaborative work session.

In step 170, the method 100 solicits feedback from the session participants in order to name the collective clusters formed in step 150. Each participant is asked to rank suggested names (e.g., taken from all of the participants' individual clusters submitted in step 140) for each collective cluster.

In one embodiment, the suggested collective cluster names are presented to each participant, who ranks the names in order of preference. In one embodiment, the method 100 asks participants to rank a specified number of suggested names (e.g., the top three choices).

In one embodiment, the method 100 employs a Jaccard similarity metric between two collective clusters (e.g., the cardinality of the intersection divided by the cardinality of the union) to define a percentage of similarity between the collective clusters. This approach would allow the method 100 to provide an initial ranking of the suggested collective cluster names before they are presented to the participants for active ranking, since participants' individual cluster names having higher Jaccard similarity values will be ranked more highly than those having lower similarity values. This approach also ensures that each suggested name is assigned to only one collective cluster (e.g., since it is possible to determine the collective cluster that is closest to the participant cluster from which the name came).

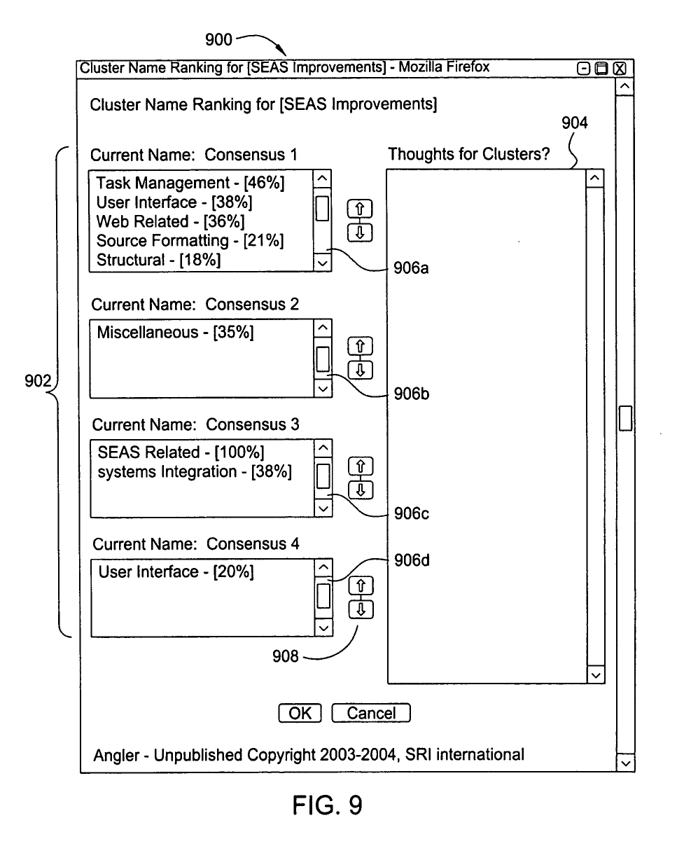

FIG. 9 illustrates one embodiment of a display 900 for enabling participants to contribute and/or rank suggested names for collective clusters. In one embodiment, the display 900 includes two main areas: a ranking area 902 and an idea area 904. The ranking area 902 includes a ranking field 906a-906d for every collective cluster formed in step 150. Each ranking field 906a-906d lists the suggested names for its respective collective cluster. In one embodiment, each suggested name is associated with a percentage that represents a Jaccard similarity metric as described above. Thus, for example, if a suggested name comes from a participant cluster having an identical composition to the collective cluster (e.g., both clusters contain all of the same ideas), the suggested name would have a percentage score of 100% (e.g., because the intersection and union of the elements is exactly the same). In one embodiment, buttons 908 associated with each ranking field 906a-906d allow a user to highlight a name and move it up or down in the ranking field 906a-906d. The idea area 904 displays the contents of the corresponding collective cluster as the user manipulates the suggested names in the ranking field 906a-906d.

Referring back to FIG. 1, in step 175, the method 100 then calculates the ranking results to identify and select the collectively preferred name for each collective cluster. In one embodiment, this is achieved by assigning a number of votes to each rank placement (e.g., first placement gets 10 votes, second placement gets 5 votes, etc.), and then summing the votes for each name. In another embodiment, participants are assigned a limited number “voting points” that they can distribute in any permissible quantity (e.g., limited only by the total number voting points assigned and/or already used) among suggested names.

In step 177, the method 100 reviews the selected names for the collective clusters. The method 100 then proceeds to step 179 and determines whether to accept the chosen names for the collective clusters. In one embodiment, the method 100 grants a moderator the final say on name choices for the collective clusters. In one embodiment, the names assigned to the collective clusters through participant rankings (e.g., the most highly ranked names for each collective cluster) are assigned by default, but the moderator is enabled to override these assignments or break ties by indicating a decision in step 179.

If the method 100 determines that the chosen names are not acceptable, the method 100 returns to step 170 and re-attempts to solicit participant feedback to rank potential names. Alternatively, if the method 100 determines that the chosen names for the collective clusters are acceptable, the method 100 proceeds to step 180 and generates a report of the collective work session. In one embodiment, the report generated by the method 100 in step 180 includes the named collective clusters and/or the complete history of the process leading up to the formation of the named collective clusters. In another embodiment, the report also incorporates results or history from other collaborative work sessions. The final, named collective clusters may be considered by an organization in addressing the need under scrutiny in the collective work session.

In one embodiment, the report is an electronic report that may be, for example, emailed to an individual or stored in a database. In another embodiment, the report is automatically transferred to a Structured Evidential Argumentation System (SEAS) and converted into a SEAS template, in accordance with the methods and apparatus described in co-pending, commonly assigned U.S. patent application Ser. No. 09/839,697, filed Apr. 20, 2001 by Lowrance et al., which is herein incorporated by reference. The method 100 terminates at step 185, once the report has been generated.

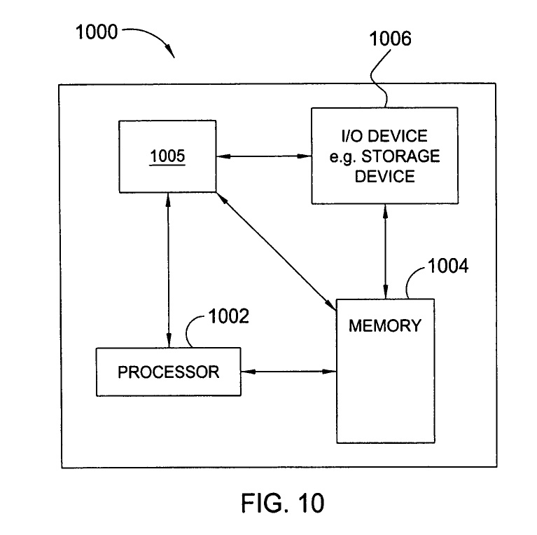

FIG. 10 is a high level block diagram of the present method for facilitating computer-supported collaborative work sessions that is implemented using a general purpose computing device 1000. In one embodiment, a general purpose computing device 1000 comprises a processor 1002, a memory 1004, a collaborative work module 1005 and various input/output (I/O) devices 1006 such as a display, a keyboard, a mouse, a modem, and the like. In one embodiment, at least one I/0 device is a storage device (e.g., a disk drive, an optical disk drive, a floppy disk drive). It should be understood that the collaborative work module 1005 can be implemented as a physical device or subsystem that is coupled to a processor through a communication channel.

Alternatively, the collaborative work module 1005 can be represented by one or more software applications (or even a combination of software and hardware, e.g., using Application Specific Integrated Circuits (ASIC)), where the software is loaded from a storage medium (e.g., I/0 devices 1006) and operated by the processor 1002 in the memory 1004 of the general purpose computing device 1000. Thus, in one embodiment, the collaborative work module 1005 for facilitating a collaborative work session described herein with reference to the preceding Figures can be stored on a computer readable medium or carrier (e.g., RAM, magnetic or optical drive or diskette, and the like).

As described above, a user may access a collaborative work session operating in accordance with the method 100 using a variety of computing devices. Moreover, the selected computing device may connect to the session using any one of a plurality of network protocols, including, but not limited to Hypertext Transport Protocol/Hypertext Markup Language (HTTP/HTML), Wireless Application Protocol (WAP), Extensible Markup Language/Simple Object Access Protocol (XML/SOAP) and Java® smart client, among others.

Thus, the present invention represents a significant advancement in the field of computer-supported collaborative work. A method is provided that enables participants in a collaborative work session to generate ideas, and group these ideas into a number of discrete clusters comprising related ideas. The present invention enables users to participate in a single collaborative work session from any geographic location to privately generate, share and view ideas with others as if involved in a synchronous meeting. The invention also enables users to participate at any time in the collaborative work session, e.g., whenever inspiration strikes or whenever time is available.

Although various embodiments which incorporate the teachings of the present invention have been shown and described in detail herein, those skilled in the art can readily devise many other varied embodiments that still incorporate these teachings.

1. A method for facilitating a computer-supported collaborative work session, the method comprising the steps of:
receiving ideas from a plurality of session participants that relate to a stated objective;
forwarding ideas collected from said session participants to at least one of said session participants;
prompting said at least one of said session participants to group said ideas into two or more participant-defined clusters of related ideas; and
aggregating said participant-defined clusters to form two or more collective clusters reflective of a consensus among said participants.

2. The method of claim 1, further comprising the step of:
receiving session parameters prior to receiving ideas from said session participants.

3. The method of claim 2, wherein said sessions parameters comprise one or more of: a description of the issue to be addressed by said session, a schedule for completing stages of said session, the participants to be included in the session, whether said participants will remain anonymous, a number of contributions each of said participants is required to contribute before being permitted to review other participants' ideas, types of files that said participants may contribute, a total number of ideas to be generated by said participants, a total number of collective clusters to be generated, a method to be used in aggregating said participant-defined clusters, constraints on activities of said participants, whether synthetic participants should be deployed in said session and how said synthetic participants will perform their functions.

4. The method of claim 2, wherein the step of receiving session parameters further comprises the step of:
receiving one or more background documents for distribution to said session participants.

5. The method of claim 1, further comprising the steps of:
soliciting preferences from said at least one of said session participants for names for said collective clusters; and
evaluating said preferences to select a collectively preferred name for each collective cluster.

6. The method of claim 1, further comprising the step of:
reporting the resultant collective clusters, the process by which the collective clusters were derived, information from other collaborative work sessions, or a combination thereof.

7. The method of claim 1, wherein the step of receiving ideas from participants further comprises:
posting ideas received from individual participants to a forum where all current participants can review one or more of the received ideas.

8. The method of claim 1, wherein the step of receiving ideas from participants further comprises:
posting, to said at least one of said session participants' display, a select number of received ideas, wherein the number of received ideas posted for said at least one of said session participants' viewing is dependent on the number of ideas said at least one of said session participants' has contributed to the session.

9. The method of claim 1, further comprising the steps of:
calculating a number of received ideas prior to prompting said session participants to generate said clusters;
determining if said number of received ideas meets a predefined minimum number; and
requesting more ideas from one or more session participants if said number of received ideas does not meet the predefined minimum number.

10. The method of claim 9, wherein said number of received ideas represents a total number of ideas received from all session participants, a number of ideas received from an individual participant, or a combination thereof.

11. The method of claim 9, wherein the step of requesting more ideas comprises:
requiring all current session participants to post at least a first idea before any individual participant is permitted to post a second idea.

12. The method of claim 1, wherein the step of aggregating said participant-defined clusters comprises the steps of:
reviewing said participant-defined clusters to determine the extent of differences in the ways that said participants have grouped said ideas; and
asking said session participants to provide alternate participant-defined clusters if the extent of the differences exceeds a predefined threshold.

13. The method of claim 12, wherein the extent of the differences is calculated using Information Theory mechanisms.

14. The method of claim 1, further comprising the step of:
soliciting participant feedback to name said collective clusters.

15. The method of claim 14, wherein said step of soliciting participant feedback comprises the steps of:
asking said session participants to rank, in order of preference, two or more names provided by said session participants during the formation of participant-generated clusters; and
calculating and selecting a collectively preferred name for each collective cluster.

16. The method of claim 1, wherein said method is monitored by a moderator that is at least one of a human moderator or a synthetic moderator.

17. The method of claim 16, wherein said moderator is enabled to do at least one of the following: filter duplicate ideas and merge closely related ideas.

18. The method of claim 16, wherein said moderator is enabled to stimulate idea generation by interjecting ideas, questions, or both to said session participants,

19. The method of claim 18, wherein said interjected ideas are drawn from a database of standard aspects of problem solving.

20. The method of claim 18, wherein said interjected ideas are generated or selected based on natural language and reasoning techniques.

21. The method of claim 18, wherein said moderator interjects ideas via one or more synthetic session participants.

22. The method of claim 21, wherein one or more of said synthetic session participants embodies a corporate memory and is enabled to access databases containing information relevant to said stated objective.

23. The method of claim 21, wherein one or more of said synthetic participants is enabled to provide a participant-generated cluster that presents a particular view on said session participants' ideas.

24. The method of claim 1, wherein results from one or more previous collaborative work sessions may be combined with a current collaborative work session.

25. A computer readable medium containing an executable program for facilitating a computer-supported collaborative work session, where the program performs the steps of:
receiving ideas from a plurality of session participants that relate to a stated objective;
forwarding ideas collected from said session participants to at least one of said session participants;
prompting said at least one of said session participants to group said ideas into two or more participant-defined clusters of related ideas; and
aggregating said participant-defined clusters to form two or more collective clusters reflective of a consensus among said participants.

26. The computer readable medium of claim 25, further comprising the step of:
receiving session parameters prior to receiving ideas from said session participants.

27. The computer readable medium of claim 26, wherein said sessions parameters comprise one or more of: a description of the issue to be addressed by said session, a schedule for completing stages of said session, the participants to be included in the session, whether said participants will remain anonymous, a number of contributions each of said participants is required to contribute before being permitted to review other participants' ideas, types of files that said participants may contribute, a total number of ideas to be generated by said participants, a total number of collective clusters to be generated, a method to be used in aggregating said participant-defined clusters, constraints on activities of said participants, whether synthetic participants should be deployed in said session and how said synthetic participants will perform their functions.

28. The computer readable medium of claim 26, wherein the step of receiving session parameters further comprises the step of:
receiving one or more background documents for distribution to by said session participants.

29. The computer readable medium of claim 25, further comprising the steps of:
soliciting preferences from said session participants for names for said collective clusters; and
evaluating said preferences to select a collectively preferred name for each collective cluster.

30. The computer readable medium of claim 25, further comprising the step of:
reporting the resultant collective clusters, the process by which the collective clusters were derived, information from other collaborative work sessions, or a combination thereof.

31. The computer readable medium of claim 25, wherein the step of receiving ideas from participants further comprises:
posting ideas received by individual participants to a forum where all current participants can review one or more of the received ideas.

32. The computer readable medium of claim 25, wherein the step of receiving ideas from participants further comprises:
posting, to said at least one of said session participants' display, a select number of received ideas, wherein the number of received ideas posted for said at least one of said session participants' viewing is dependent on the number of ideas said at least one of said session participants has contributed to the session.

33. The computer readable medium of claim 25, further comprising the steps of:
calculating a number of received ideas prior to prompting said session participants to generate said clusters;
determining if said number of received ideas meets a predefined minimum number; and
requesting more ideas from one or more session participants if said number of received ideas does not meet the predefined minimum number.

34. The computer readable medium of claim 33, wherein said number of received ideas represents a total number of ideas received from all session participants, a number of ideas received from an individual participant, or a combination thereof.

35. The computer readable medium of claim 33, wherein the step of requesting more ideas comprises:
requiring all current session participants to post at least a first idea before any individual participant is permitted to post a second idea.

36. The computer readable medium of claim 25, wherein the step of aggregating said participant-defined clusters comprises the steps of:
reviewing said participant-defined clusters to determine the extent of differences in the ways that said session participants have grouped said ideas; and
asking said session participants to provide alternate participant-defined clusters if the extent of the differences exceeds a predefined threshold.

37. The computer readable medium of claim 36, wherein the extent of the differences is calculated using Information Theory mechanisms.

38. The computer readable medium of claim 25, further comprising the step of:
soliciting participant feedback to name said collective clusters.

39. The computer readable medium of claim 38, wherein said step of soliciting participant feedback comprises the steps of:
asking said session participants to rank, in order of preference, two or more names provided by said session participants during the formation of participant-generated clusters; and
calculating and selecting a collectively preferred name for each collective cluster.

40. The computer readable medium of claim 25, wherein said method is monitored by a moderator that is at least one of a human moderator or a synthetic moderator.

41. The computer readable medium of claim 40, wherein said moderator is enabled to do at least one of the following: filter duplicate ideas and merge closely related ideas.

42. The computer readable medium of claim 40, wherein said moderator is enabled to stimulate idea generation by interjecting ideas, questions, or both to said session participants,

43. The computer readable medium of claim 42, wherein said interjected ideas are drawn from a database of standard aspects of problem solving.

44. The computer readable medium of claim 42, wherein said interjected ideas are generated or selected based on natural language and reasoning techniques.

45. The computer readable medium of claim 42, wherein said moderator interjects ideas via one or more synthetic session participants.

46. The computer readable medium of claim 45, wherein one or more of said synthetic session participants embodies a corporate memory and is enabled to access databases containing information relevant to said stated objective.

47. The computer readable medium of claim 45, wherein one or more of said synthetic participants is enabled to provide a participant-generated cluster that presents a particular view on said session participants' ideas.

48. The computer readable medium of claim 25, wherein results from one or more previous collaborative work sessions may be combined with a current collaborative work session.

49. Apparatus for facilitating a computer-supported collaborative work session, the apparatus comprising:
means for receiving ideas from session participants that relate to a stated objective;
means for prompting said participants to group said ideas into two or more participant-defined clusters of related ideas; and
means for aggregating said participant-defined clusters to form two or more collective clusters reflective of a consensus among said participants.

50. A method for facilitating a computer-supported collaborative work session, the method comprising the steps of:
receiving ideas from session participants that relate to a stated objective; and
prompting said participants, via questions or ideas submitted through a synthetic session participant, if said participants do not generate a predefined minimum number of ideas or if a rate of idea generation appears to be slowing.

51. The method of claim 50, further comprising:
prompting said participants to group said ideas into two or more preliminary clusters of related ideas; and
aggregating said preliminary clusters to form two or more collective clusters reflective of a consensus among said participants.

52. Apparatus for facilitating a computer-supported collaborative work session, the apparatus comprising:
means for receiving ideas from session participants that relate to a stated objective; and
means for prompting said participants, via questions or ideas submitted through a synthetic session participant, if said participants do not generate a predefined minimum number of ideas or if a rate of idea generation appears to be slowing.

53. A method for participating in a computer-supported collaborative work session, the method comprising the steps of:
providing one or more ideas that relate to a stated objective;
receiving ideas collected from other session participants; and
grouping said received ideas into two or more participant-defined clusters of related ideas.

54. Apparatus for enabling a user to participate in a computer-supported collaborative work session, the apparatus comprising:
means for providing one or more ideas that relate to a stated objective;
means for receiving ideas collected from other session participants; and
means for grouping said received ideas into two or more participant-defined clusters of related ideas.

55. A method for participating in a computer-supported collaborative work session, the method comprising the steps of:
providing one or more ideas that relate to a stated objective; and
receiving prompts, via questions or ideas submitted through a synthetic session participant, if said provided ideas do not satisfy a predefined minimum number of ideas or if a rate of idea generation appears to be slowing.

56. Apparatus for enabling a user to participate in a computer-supported collaborative work session, the apparatus comprising:
means for providing one or more ideas that relate to a stated objective; and
means for receiving prompts, via questions or ideas submitted through a synthetic session participant, if said provided ideas do not satisfy a predefined minimum number of ideas or if a rate of idea generation appears to be slowing.
